(19) United States
(12) Patent Application Publication
(10) Pub. No.: US 2017/0305301 A1
(43) Pub. Date: Oct. 26, 2017

(54) VEHICLE SEAT SENSOR SYSTEMS FOR USE WITH OCCUPANT CLASSIFICATION SYSTEMS

(71) Applicant: BeBop Sensors, Inc., Berkeley, CA (US)

(72) Inventors: Keith A. McMillen, Berkeley, CA (US); Kyle Lobedan, Oakland, CA (US); William Walls, Berkeley, CA (US)

(21) Appl. No.: 15/479,103

(22) Filed: Apr. 4, 2017

Related U.S. Application Data
(60) Provisional application No. 62/326,565, filed on Apr. 22, 2016.

(51) Int. Cl. B60N 2/00; G01L 1/18; G01L 25/00; B60W 40/08

(52) U.S. Cl. CPC B60N 2/002; G01L 25/00; B60W 40/08; G01L 1/18; B60W 2040/0881

(57) ABSTRACT

Vehicle seat sensor systems for use with occupant classification systems (OCS) are described.

### RELATED APPLICATION DATA

The present application is a non-provisional of and claims priority under 35 U.S.C. 119(e) to U.S. Provisional Patent Application No. 62/326,565 for Vehicle Seat Sensor Systems for Use With Occupant Classification Systems filed on Apr. 22, 2016 (Attorney Docket No. BBOPP010P), the entire disclosure of which is incorporated herein by reference for all purposes.

### BACKGROUND

Occupant Detection Systems (ODS) determine whether to enable or disable an airbag in a vehicle. The concept of an occupant classification system (OCS) has been developing in recent years. An OCS integrates with a Dynamic Airbag Suppression System (DASS). The purpose of an OCS is to gather enough information to be able to determine who or what is in a vehicle seat for the purpose of controlling the force of deployment of a multi-stage airbag. Currently most vehicles have only an ODS implemented, for example, with a simple pressure switch activated by a liquid-filled bladder in the seat. This rudimentary mechanism indicates whether an object is in the seat that weighs more than 65 pounds for the purpose of enabling the passenger air bag. However, this approach does not provide any information as to whether the object is a human being, let alone the size or seating position of that human being.

### SUMMARY

According to a first class of implementations, a sensor system includes an array of sensors arranged in a flexible assembly. The flexible assembly is configured for integration with a seat. Each sensor includes a piezoresistive element and a sensor trace pattern including two closely spaced conductive sensor traces. Each sensor also is connected to a pair of conductive routing traces configured to receive a drive signal and transmit a sensor signal. Each sensor signal is representative of a force applied to the corresponding sensor. The sensor trace patterns and the conductive routing traces for the sensors of the array are formed on a flexible substrate. The piezoresistive elements for the sensors of the array are secured to the flexible substrate in contact with the corresponding sensor trace patterns. Sensor circuitry is connected to the conductive routing traces and configured to selectively energize the sensors of the array with the drive signals and to receive the sensor signals.

According to a particular implementation of the first class of implementations, the sensor system includes a plurality of temperature sensing elements formed on the flexible substrate. Each of the temperature sensing elements is configured to generate a temperature signal representative of a temperature of the flexible assembly in a vicinity of the temperature sensing element. The sensor circuitry is configured to receive the temperature signals, and to modify force values derived from the sensor signals using correction values corresponding to the temperature signals.

According to a particular implementation of the first class of implementations, the sensor system includes one or more barometric pressure sensing elements. Each of the barometric pressure sensing elements is configured to generate a pressure signal representative of a barometric pressure in a vicinity of the barometric pressure sensing element. The sensor circuitry is configured to receive each pressure signal, and to modify force values derived from the sensor signals using correction values corresponding to each pressure signal.

According to a particular implementation of the first class of implementations, the flexible assembly includes two portions. A first portion of the assembly is configured for alignment with a top of a seat cushion of the seat, and a second portion of the assembly is configured for alignment with a front of the seat cushion of the seat.

According to a particular implementation of the first class of implementations, the sensor system is configured for integration with one or more of a seat cushion of the seat, a back cushion of the seat, and/or a headrest of the seat.

According to a particular implementation of the first class of implementations, the sensor system includes an additional array of sensors arranged in an additional flexible assembly, the additional flexible assembly being configured for integration with a floor adjacent the seat.

According to a particular implementation of the first class of implementations, the piezoresistive elements are secured to the flexible substrate with a material that forms a hermetic seal with the flexible substrate around each sensor.

According to a particular implementation of the first class of implementations, the flexible assembly has a plurality of cut-out apertures between subsets of the sensors of the array such that each subset of the sensors of the array has a degree of independent motion relative to other subsets of the sensors of the array.

According to a particular implementation of the first class of implementations, the sensor trace patterns and the conductive routing traces for the sensors of the array include one or more conductive inks screen printed on the flexible substrate.

According to a particular implementation of the first class of implementations, the sensor system the sensor circuitry is configured to process the sensor signals to generate force data representing a distribution of force magnitudes over one or more areas of the seat. According to a more specific implementation, the force data represent the distribution of the force magnitudes over time. According to another specific implementation, the sensor circuitry is configured to transmit the force data to an occupant classification system of a vehicle in which the seat is included.

According to a particular implementation of the first class of implementations, the sensor circuitry is configured to process the sensor signals to identify a type of object or a type of occupant in the seat.

According to a second class of implementations, a vehicle seat includes a chassis, one or more cushions, a seat cover securing the cushions to the chassis, and a sensor system. The sensor system includes an array of sensors arranged in a flexible assembly. The flexible assembly is adjacent the one or more cushions within the seat cover. Each sensor includes a piezoresistive element and a sensor trace pattern including two closely spaced conductive sensor traces. Each sensor also is connected to a pair of conductive routing traces configured to receive a drive signal and transmit a sensor signal. Each sensor signal is representative of a force applied to the corresponding sensor. The sensor trace patterns and the conductive routing traces for the sensors of the array are formed on a flexible substrate. The piezoresistive elements for the sensors of the array are secured to the flexible substrate in contact with the corresponding sensor trace patterns. Sensor circuitry is connected to the conductive routing traces and configured to selectively energize the sensors of the array with the drive signals and to receive the sensor signals. The sensor circuitry is configured to generate force data using the sensor signals. The force data represent a distribution of force magnitudes over one or more areas of the vehicle seat. An interface is configured to transmit communications based on the force data to an automotive system of a vehicle in which the vehicle seat is mounted.

According to a particular implementation of the second class of implementations, the sensor system includes a plurality of temperature sensing elements formed on the flexible substrate. Each of the temperature sensing elements is configured to generate a temperature signal representative of a temperature of the flexible assembly in a vicinity of the temperature sensing element. The sensor circuitry is configured to receive the temperature signals, and to modify force values derived from the sensor signals using correction values corresponding to the temperature signals.

According to a particular implementation of the second class of implementations, the sensor system includes one or more barometric pressure sensing elements. Each of the barometric pressure sensing elements is configured to generate a pressure signal representative of a barometric pressure in a vicinity of the barometric pressure sensing element. The sensor circuitry is configured to receive each pressure signal, and to modify force values derived from the sensor signals using correction values corresponding to each pressure signal.

According to a particular implementation of the second class of implementations, the flexible assembly includes two portions. A first portion of the assembly is aligned with a top of a seat cushion of the seat. A second portion of the assembly is aligned with a front of the seat cushion of the seat.

According to a particular implementation of the second class of implementations, the sensor system is aligned with one or more of a seat cushion of the seat, a back cushion of the seat, and/or a headrest of the seat.

According to a particular implementation of the second class of implementations, the piezoresistive elements are secured to the flexible substrate with a material that forms a hermetic seal with the flexible substrate around each sensor.

According to a particular implementation of the second class of implementations, the sensor system, the flexible assembly has a plurality of cut-out apertures between subsets of the sensors of the array such that each subset of the sensors of the array has a degree of independent motion relative to other subsets of the sensors of the array.

According to a particular implementation of the second class of implementations, the sensor trace patterns and the conductive routing traces for the sensors of the array include one or more conductive inks screen printed on the flexible substrate.

According to a particular implementation of the second class of implementations, the automotive system is an occupant classification system, and the sensor circuitry is configured to transmit the force data to the occupant classification system via the interface.

According to a particular implementation of the second class of implementations, the sensor circuitry is configured to process the force data to identify a type of object or a type of occupant in the seat.

A further understanding of the nature and advantages of various implementations may be realized by reference to the remaining portions of the specification and the drawings.

### BRIEF DESCRIPTION OF THE DRAWINGS

FIG. 1 is an exploded view of a particular implementation of a seat sensor system.

FIG. 2 shows an example of how a seat sensor system may be integrated with a vehicle seat.

FIG. 3 is a simplified block diagram of sensor circuitry for use with particular implementations.

FIG. 4 illustrates variation of sensor response with temperature.

FIG. 5 illustrates the use of temperature sensors with a particular implementation of a seat sensor system.

FIG. 6 illustrates the use of cutouts with a particular implementation of a seat sensor system.

FIG. 7 illustrates various material layers for particular implementations of a seat sensor system.

FIGS. 8A-8E provide visual illustrations of forces represented by seat sensor force data.

### DETAILED DESCRIPTION

The present disclosure describes and enables seat sensor systems that may be used with occupant classification systems (OCS) and that are capable of providing significantly more detail about what is in a vehicle seat than previous sensors. Various specific implementations are described herein including the best modes contemplated. Examples of these implementations are illustrated in the accompanying drawings. However, the scope of this disclosure is not limited to the described implementations. Rather, this disclosure is intended to cover alternatives, modifications, and equivalents of these implementations. In the following description, specific details are set forth in order to provide a thorough understanding of the described implementations. Some implementations may be practiced without some or all of these specific details. In addition, well known features may not have been described in detail to promote clarity.

Piezoresistive materials include any of a class of materials that exhibit a change in electrical resistance in response to mechanical force (e.g., pressure, impact, distortion, etc.) applied to the material. One class of sensors described herein includes conductive traces formed directly on or otherwise integrated with a flexible dielectric substrate with piezoresistive material that is adjacent and/or tightly integrated with the dielectric substrate and in contact with portions of the traces. Another class of sensors described herein includes conductive traces formed directly on or otherwise integrated with a flexible substrate of piezoresistive material, e.g., a piezoresistive fabric or other flexible material. When force is applied to such a sensor, the resistance between traces connected by the piezoresistive material changes in a time-varying manner that is representative of the applied force.

A signal representative of the magnitude of the applied force is generated based on the change in resistance. This signal is captured via the conductive traces (e.g., as a voltage or a current), digitized (e.g., via an analog-to-digital converter), processed (e.g., by an associated processor, controller, or suitable circuitry), and mapped (e.g., by the associated processor, controller, or circuitry, or a separate control system) to a control function that may be used in conjunction with the control and/or operation of virtually any type of process, device, or system. It should be noted that the output signals from such sensors may also be used in some cases to detect a variety of distortions and/or deformations of the substrate(s) on which they are formed or with which they are integrated such as, for example, bends, stretches, torsions, rotations, etc. In addition, arrays of sensors having various configurations may be used for different applications.

Printing, screening, depositing, thermally transferring, or otherwise forming conductive traces on flexible substrates allows for the creation of a sensor or sensor array that fits any arbitrary shape or volume such as, for example, the contours of a vehicle seat as described herein. The piezoresistive material with which the traces are in contact or on which the traces are formed may be any of a variety of woven and non-woven fabrics having piezoresistive properties. Implementations are also contemplated in which the piezoresistive material may be any of a variety of flexible, stretchable, or otherwise deformable materials (e.g., rubber, or a stretchable fabric such as spandex or open mesh fabrics) having piezoresistive properties. The conductive traces may be formed on the flexible dielectric substrate or the piezoresistive material using any of a variety of conductive inks or paints. More generally, implementations are contemplated in which the conductive traces are formed using any conductive material that may be formed on a flexible substrate. It should be understood with reference to the foregoing that, while specific implementations are described with reference to specific materials and techniques, the scope of this disclosure is not so limited.

Both one-sided and two-side implementations are contemplated, e.g., conductive traces can be printed or formed on one or both sides of a flexible substrate. As will be understood, two-sided implementations may require some mechanism for connecting conductive traces on one side of the substrate to those on the other side. Some implementations use vias in which conductive ink or paint is flowed through the vias to establish the connections. Alternatively, conductive vias or rivets may make connections through the flexible substrate. Both single and double-sided implementations may also use insulating dielectric materials formed over or under conductive traces. This allows for the stacking or layering of conductive traces and signal lines, e.g., to allow the routing of signal lines to isolated structures in a manner analogous to the different layers of a printed circuit board.

Routing of signals on and off the flexible substrate may be achieved in a variety of ways. For example, some implementations might use elastomeric connectors (e.g., ZEBRA® connectors) which alternate conductive and non-conductive rubber at a density typically an order of magnitude greater than the width of the conductive traces to which they connect (e.g., at the edge of the substrate). Alternatively, a circuit board (possibly made of a flexible material such as Kapton), or a bundle of conductors may be riveted or otherwise secured to the substrate. The use of rivets may also provide mechanical reinforcement to the connection.

According to some implementations, matching conductive traces or pads on the flexible substrate and a circuit board can be secured to each other using, for example, a layer of conductive adhesive (e.g., a conductive epoxy such as Masterbond EP79 from Masterbond, Inc. of Hackensack, N.J.) applied to one or both of the surfaces which are then mated to each other. The conductive traces or pads can also be held together with additional mechanical elements such as sonic welds or rivets. If conductive rivets are used to make the electrical connections to the conductive traces of the flexible substrate, the conductive adhesive may not be required. Conductive threads may also be used to connect the conductive traces of the flexible substrate to an external assembly. The wide range of variations within the scope of this disclosure will be apparent to those of skill in the art.

According to a particular class of implementations, the piezoresistive material is a pressure sensitive fabric manufactured by Eeonyx, Inc., of Pinole, Calif. The fabric includes conductive particles that are polymerized to keep them suspended in the fabric. The base material is a polyester felt selected for uniformity in density and thickness as this promotes greater uniformity in conductivity of the finished piezoresistive fabric. The mechanical uniformity of the base material results in a more even distribution of conductive particles when a slurry containing the conductive particles is introduced. The fabric may be woven. Alternatively, the fabric may be non-woven such as, for example, a calendared fabric, e.g., fibers bonded together by chemical, mechanical, heat, or solvent treatment. For implementations in which conductive traces are formed on the piezoresistive fabric, calendared material may present a smooth outer surface which promotes more accurate screening of conductive inks.

The conductive particles in the fabric may be any of a wide variety of materials including, for example, silver, copper, gold, aluminum, carbon, etc. Some implementations may employ carbon graphenes that are formed to grip the fabric. Such materials may be fabricated using techniques described in U.S. Pat. No. 7,468,332 for Electroconductive Woven and Non-Woven Fabric issued on Dec. 23, 2008, the entire disclosure of which is incorporated herein by reference for all purposes. However, it should again be noted that any of a wide variety of materials that exhibit a change in resistance or conductivity when force is applied to the material may be suitable for implementation of sensors as described herein.

According to a particular class of implementations, conductive traces having varying levels of conductivity are formed on a flexible dielectric substrate or flexible piezoresistive material using conductive silicone-based inks manufactured by, for example, E.I. du Pont de Nemours and Company (DuPont) of Wilmington, Del., and/or Creative Materials of Ayer, Mass. An example of a conductive ink suitable for implementing highly conductive traces for use with various implementations is product number 125-19 from Creative Materials, a flexible, high temperature, electrically conductive ink. Examples of conductive inks for implementing lower conductivity traces for use with various implementations are product numbers 7102 and 7105 from DuPont, both carbon conductive compositions. Examples of dielectric materials suitable for implementing insulators for use with various implementations are product numbers 5018 and 5036 from DuPont, a UV curable dielectric and an encapsulant, respectively. These inks are flexible and durable. The degree of conductivity for different traces and applications may be controlled by the amount or concentration of conductive particles (e.g., silver, copper, aluminum, carbon, etc.) suspended in the silicone. These inks can be screen printed or printed from an inkjet printer. According to some implementations, the substrate on which the inks are printed are non-stretchable allowing for the use of less expensive inks that are low in flexibility. Another class of implementations uses conductive paints (e.g., carbon particles mixed with paint) such as those that are commonly used for EMI shielding and ESD protection.

Additional examples of sensors, arrays of sensors, and related techniques that may be used with various implementations enabled by the present disclosure are described in U.S. Patent Publication No. 2015/0331522 entitled Piezoresistive Sensors and Applications filed on Jun. 9, 2014 (Attorney Docket No. BBOPP004), and U.S. Patent Publication No. US 2015/0331523 entitled Two-Dimensional Sensor Arrays filed on Aug. 20, 2014 (Attorney Docket No. BBOPP004X1), the entire disclosures of both of which are incorporated herein by reference for all purposes. However, it should also be noted that implementations are contemplated that employ a variety of other suitable sensor technologies.

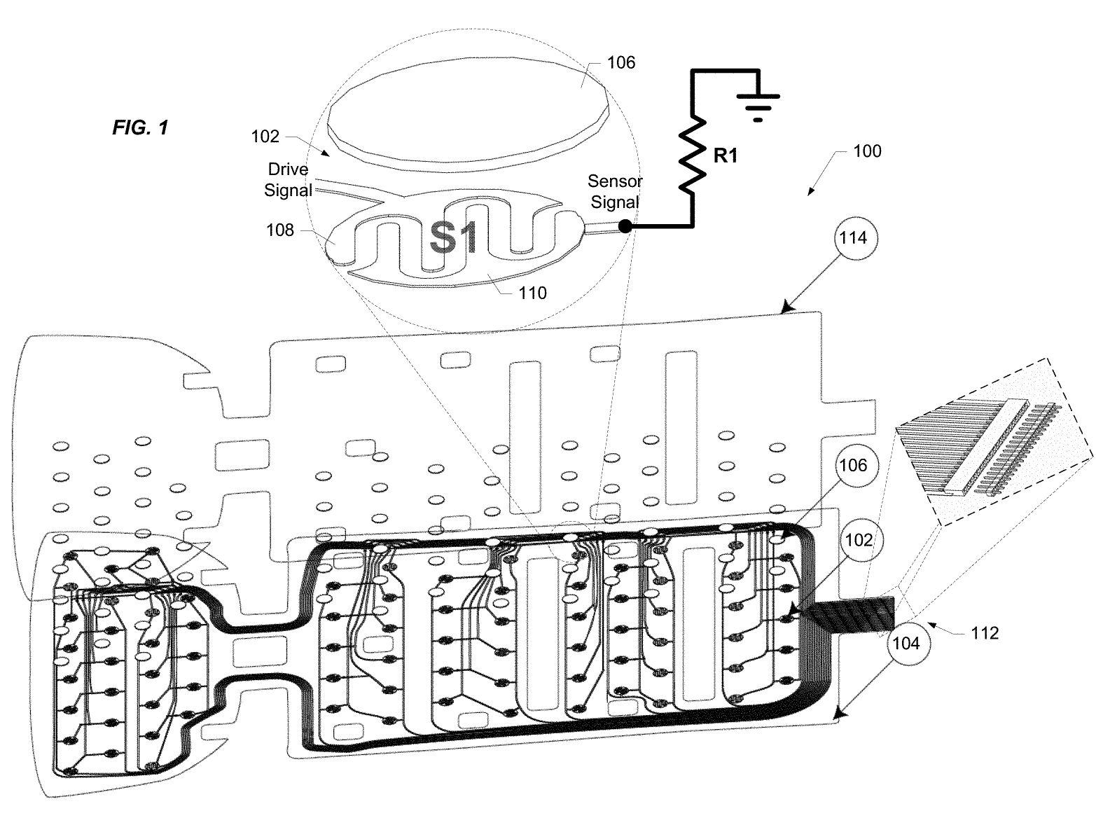

FIG. 1 illustrates an example of sensor system 100 enabled by the present disclosure that may be incorporated in a vehicle seat. Sensor system 100 may be integrated with the seat in a variety of ways such as, for example, under the seat cushion, as part of the suit cushion, as part of a seat cover, between the cushion and the seat cover, etc. The specific implementation shown in FIG. 1 is an exploded view that includes 78 sensors that capture data from different areas of the vehicle seat. The sensors are implemented with conductive trace patterns 102 that are formed directly on or otherwise integrated with a flexible substrate 104. In the depicted implementation, flexible substrate 104 is a dielectric material. At each sensor location, a patch 106 of a flexible piezoresistive material is tightly integrated with dielectric material 104 such that it makes contact with a corresponding one of the sensor trace patterns 102.

Each of sensor trace patterns 102 in the array includes two closely spaced traces, the respective patterns of which include extensions that alternate. See, for example, the magnified view of sensor S1. One of the traces 108 receives a drive signal; the other trace 110 transmits the sensor signal to associated sensor circuitry (not shown). The drive signal might be provided, for example, by connecting the trace (permanently or temporarily) to a voltage reference, a signal source that may include additional information in the drive signal, a GPIO (General Purpose Input Output) pin of an associated processor or controller, etc. And as shown in the example in FIG. 1, the sensor signal might be generated using a voltage divider in which one of the resistors of the divider includes the resistance between the two traces through the intervening piezoresistive material. The other resistor (represented by R1) might be included, for example, with the associated sensor circuitry. As the resistance of the piezoresistive material changes with applied force, the sensor signal also varies as a divided portion of the drive signal. The sensors are energized (via the drive signals) and interrogated (via the sensor signals) to generate an output signal for each that is a representation of the force exerted on that sensor. As will also be appreciated, and depending on the application, implementations are contemplated having more or fewer sensors.

According to various implementations, different sets of sensors may be selectively energized and interrogated thereby reducing the number and overall area of traces on the substrate, as well as the connections to sensor circuitry, e.g., via a connector (not shown) connected to the assembly at tail 112. In the sensor system depicted in FIG. 1, the 78 sensors are driven via 6 drive signal outputs from the sensor circuitry, and the sensor signals are received via 14 sensor signal inputs to the sensor circuitry; requiring only 20 connections between the substrate and the connector (see the magnified view of tail 112). This may be compared to an implementation in which each sensor has its own dedicated pair of signal lines (i.e., 78 sensors; 156 signal lines). The set of sensors providing sensor signals to one of the 14 sensor signal inputs to the sensor circuitry may be energized in any suitable sequence or pattern such that any signal received on the corresponding sensor signal input can be correlated with the corresponding sensor drive signal by the sensor circuitry.

And because the sensor signals in this implementation are received by the sensor circuitry via multiple different sensor signal inputs, multiple sensors can be simultaneously energized as long as they are connected to different sensor signal inputs to the sensor circuitry. This allows for the sharing of drive signal lines. The sharing of common drive signal lines may be enabled in some cases by insulators which allow the conductive traces to cross. In other cases, the conductive traces might simply diverge. In still other cases, sensors may share common drive signals that originate and then diverge before reaching the assembly. Thus, in the implementation shown, only 6 drive signals are needed for energizing the 78 sensors.

More generally, the number of signal lines used to drive the sensors of the array, the number of signal lines used to capture the sensor signals, and the manner in which the signal lines in each group may be shared will vary considerably from implementation to implementation. Some of the issues that influence design decisions around this include, for example, the topology of the array. That is, these design choices are highly dependent on how a signal exits each sensor and how well each lines up with the location of the assembly that connects to the outside world (e.g., the connector, a PCB interface, etc.). Another issue relates to sensor output levels. That is, if the sensor output levels are expected to be low, it may be advantageous to provide a more direct path to the connector or sensor circuitry by having more lines for sensor signals with fewer sensors sharing each line. This also may have the advantage of reducing crosstalk between sensors. And for implementations in which even small amounts of crosstalk are undesirable, the lines carrying the sensor output signals to the sensor circuitry may be terminated with a non-inverting op-amp which presents virtual ground. Other suitable variations on this theme will be understood by those of skill in the art to be within the scope of this disclosure.

According to a particular implementation, trace patterns 102 are screen printed on substrate 104 which may be a flexible PET (polyethylene terephthalate) substrate about 5 mils thick. The PET has conductive traces as well as dielectric insulating material at locations at which the traces cross each other, allowing for complicated patterns and routing to isolated structures. According to a specific implementation, the traces are formed using a silk screening process which deposits ink1, dielectric, then ink2. As will be appreciated, more complicated topologies are contemplated.

Piezoresistive patches 106 are adhered to a substrate 114 which may be a non-permeable, flexible material such as, for example, a thermally transferable polyurethane or TPU, such as those available from Bemis Associates Inc. of Shirley, Mass. Piezoresistive patches 106 may be adhered to the TPU by selective heating or using a suitable adhesive, e.g., a dot of glue. In another example, the piezoresistive patches could be punched with an adhesive on the back (e.g., a pressure sensitive adhesive such as 3M 468MP commonly referred to as double sided tape). According to a particular implementation, a stacked adhesive is used that includes, from the piezoresistive patch down: 3M 468, 0.05 PET, and acrylic PSA, which is bonded to the TPU of substrate 114. Alternatively, substrate 114 could be a PET substrate with pressure sensitive adhesive applied to one surface for adhering the piezoresistive patches and then for adhering to substrate 104.

Substrate 114 with patches 106 is positioned relative to substrate 104 so patches 106 line up with sensor trace patterns 102. The substrates are then thermally pressed together so substrate 114 melts into substrate 104 (for implementations in which substrate 114 is a TPU), forming a hermetic seal around each of the sensors (i.e., a piezo patch and the corresponding trace pattern) and the routing traces leading to the connector. The seal provides environmental protection for the sensors and traces and helps hold the individual sensor components in position resulting in a robust and tightly integrated unit. Environmental protection can be particularly advantageous for the conductive inks from which the sensors and traces are constructed given their tendency to oxidize and degrade over time when exposed to various environmental contaminants. As will be appreciated, the number and configuration of sensors may vary depending, for example, on seat design, desired resolution, etc.

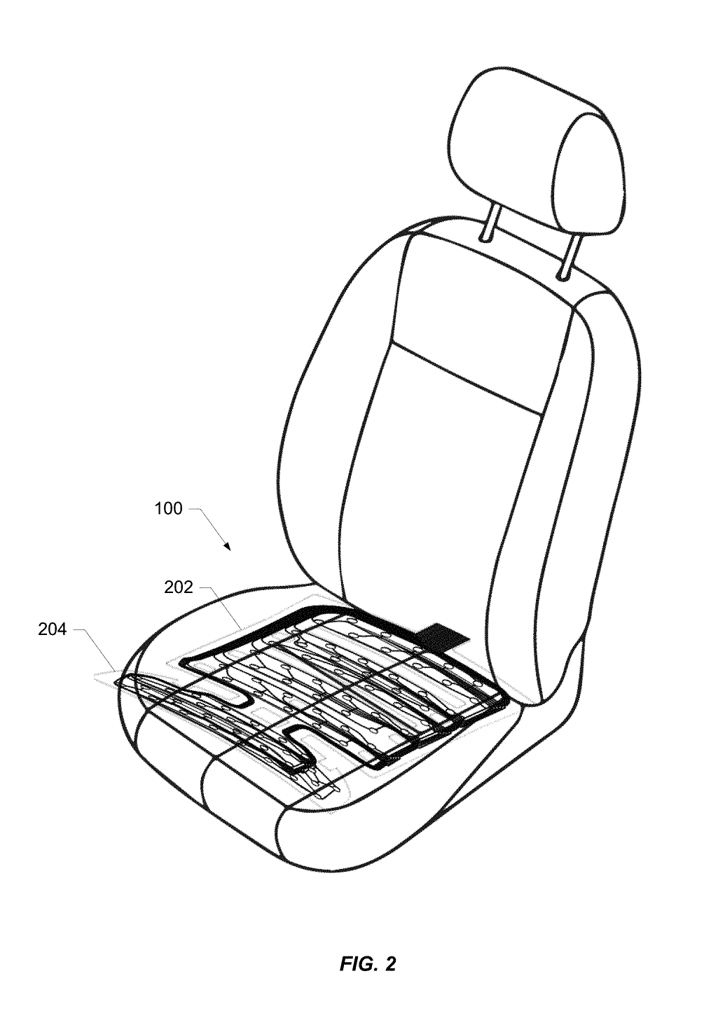

FIG. 2 shows how a sensor system such as sensor system 100 of FIG. 1 might be oriented relative to a vehicle seat. The main section 202 of the assembly is positioned to sense forces exerted on the top surface of the bottom seat cushion. The front section 204 of the assembly (connected to section 202 by a narrower neck) folds down over the front of the bottom seat cushion, being positioned to sense forces against the front of the cushion that might be exerted, for example, by the calves of the occupant; particularly a smaller occupant.

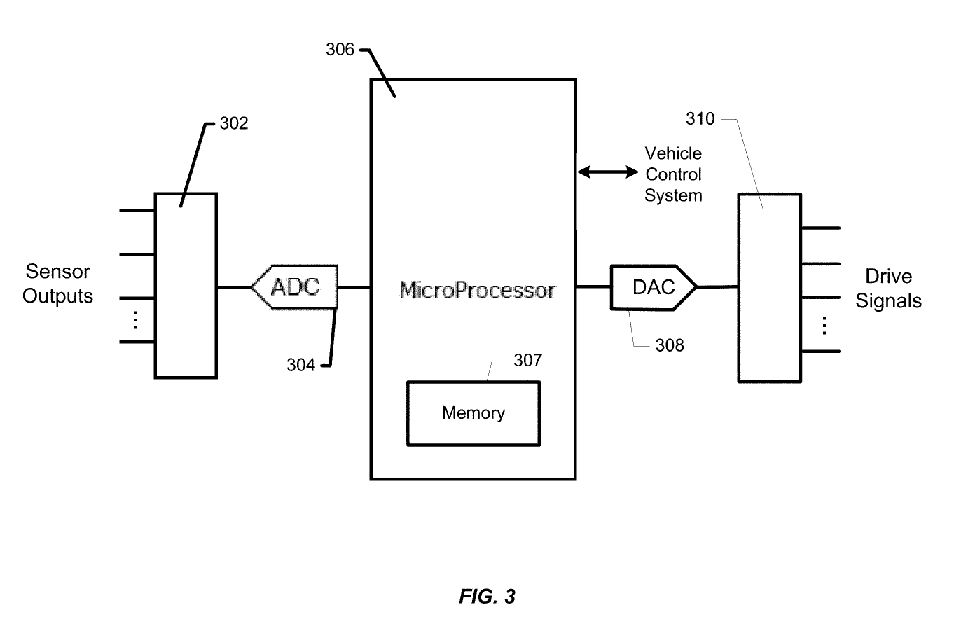

FIG. 3 is a simplified diagram of sensor circuitry that may be provided on a PCB or other connected assembly for use with implementations described herein. For example, in the implementation described above with reference to FIG. 1, such sensor circuitry could be connected to the conductive traces on substrate 104 via a connector at tail 112. When pressure is applied to one of the sensors, a resulting signal (captured via the corresponding traces) is received and digitized (e.g., via multiplexer 302 and A-to-D converter 304) and may be processed locally (e.g., by processor 306) and/or transmitted to a connected device (e.g., via a wired or wireless connection). The sensors may be selectively energized by the sensor circuitry (e.g., under the control of processor 306 via D-to-A converter 308 and multiplexer 310) to effect the generation of the sensor signals. Processor 306 may communicate with a remote vehicle control system (e.g., an airbag control system) via a wired or wireless interface. Power may be provided to the sensor circuitry using any of a variety of mechanisms including one or more batteries, a connection to the vehicle's electrical system, etc. And as will be appreciated, the sensor circuitry shown in FIG. 3 is merely an example. A wide range of sensor circuitry components, configurations, and functionalities are contemplated. According to a particular implementation, processor 306 may be implemented with the C8051F380-GM controller or its automotive-temperature-rated equivalent the C8051F501 (both provided by Silicon Labs of Austin, Tex.).

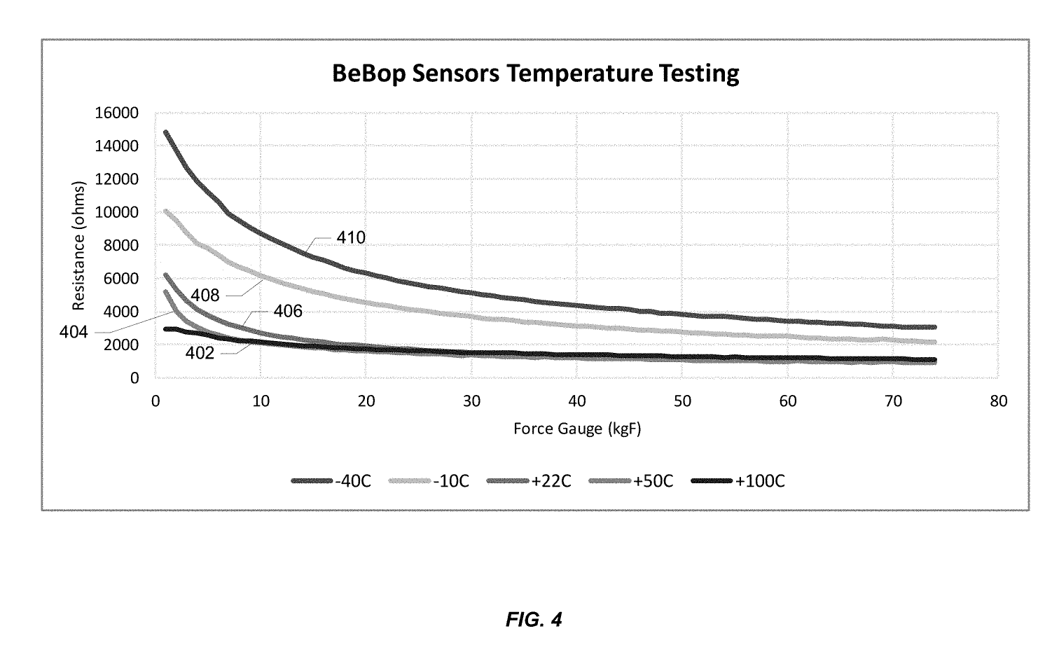

Because some sensor systems enabled by the present disclosures are intended to be deployed in vehicles, the range of temperatures for which such systems are designed to operate goes from −40° C. to 100° C. According to some implementations, the response of the sensors changes in a known manner with temperature as shown in FIG. 4. Each curve represents the relationship between the force exerted on an individual sensor (e.g., sensor S1 of FIG. 1) in kilograms and the resistance of the piezoresistive material of the sensor (e.g., patches 106 of FIG. 1) in ohms at a particular temperature. Curve 402 corresponds to 100° C.; curve 404 to 50° C.; curve 406 to 22° C.; curve 408 to −10° C.; and curve 410 to −40° C. As illustrated in FIG. 4, the change in sensor response over temperature can be significant. It is therefore useful to have some way of monitoring temperature so as to account for these variations.

A thermocouple is an electrical device including two dissimilar conductors having an electrical junction that generates a temperature-dependent voltage as a result of the thermoelectric effect. This voltage can be used to measure temperature. Some conventional thermocouples are built by welding, for example, a copper wire to a nickel wire. As the combination is heated or cooled it produces a small amount of electricity representative of the temperature. However, traditional thermocouples may be too bulky to put in a seat cushion.

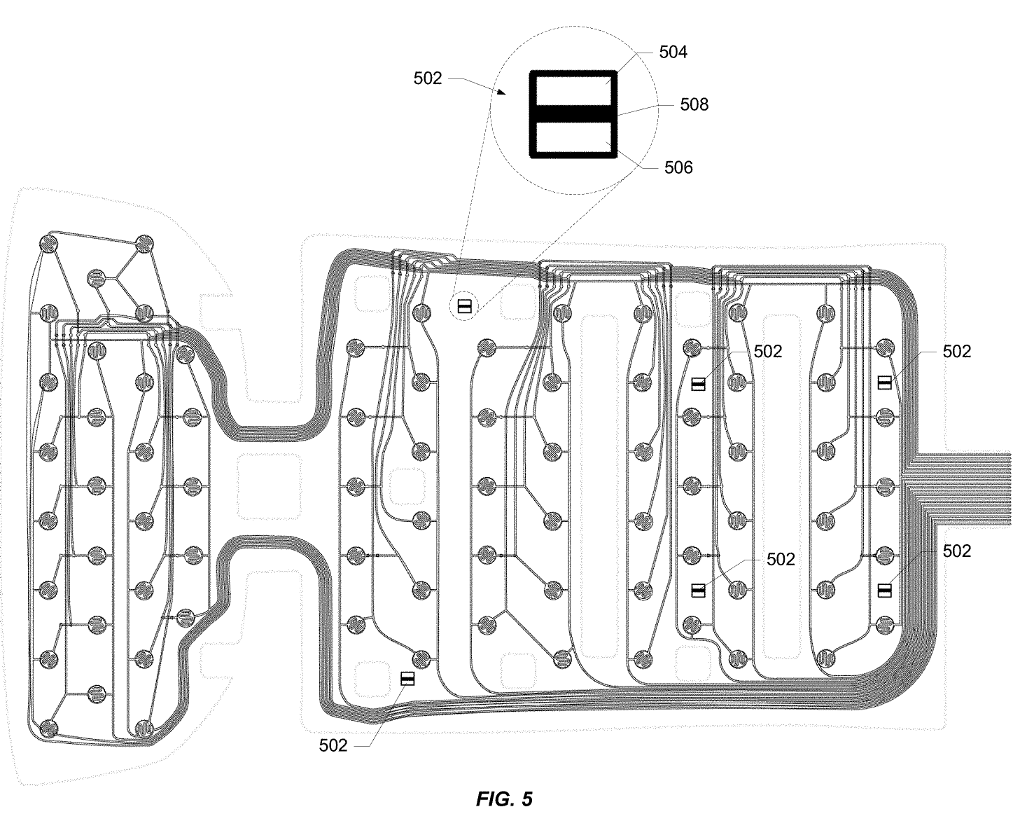

According to a particular implementation illustrated in FIG. 5, thermocouples 502 comprising two dissimilar metals 504 and 506 are provided in the assembly so that the temperature of the system can be monitored for the purpose of appropriately adjusting the sensor outputs to account for temperature. One of the thermocouple metals may be, for example, a powdered metal (e.g., nickel, steel, constantan, or the like) dispersed in an ink composition with a sufficiently high concentration. This component of the thermocouple may be screen printed (e.g., on substrate 104) in conjunction with the printing of the conductors and insulators of the sensors. The other metal component of the thermocouple (e.g., a copper film) may be adhered to the substrate on which the piezoresistive patches are adhered (e.g., substrate 114) as described above, with the contact between the two thermocouple components being made when the substrates are aligned and secured to each other. Black strip 508 represents the region of overlap of the two metals. According to a particular implementation, in which the substrate to which the copper film is adhered is a TPU, securing the two substrates together provides sufficient pressure to electrically connect the two thermocouple components. Each of the thermocouples has its own set of traces (not shown for clarity) that are routed to the connector at the tail of the assembly. The pair of traces connecting each thermocouple to the connector are routed along with the traces for each of the sensors with each of thermocouple components being connected to one of the traces. It should be noted that other thermally responsive devices may be used as temperature sensing elements for monitoring system temperatures including, for example, resistance temperature detectors (RTDs) which measure temperature by correlating the resistance of the RTD element (usually a pure metal such as nickel or copper) with temperature, or thermistors which use a ceramic or a polymer that changes resistance with temperature. Other suitable devices are known to those of skill in the art.

In the depicted implementation, six thermocouples are shown distributed on the assembly among the sensors and sensor routing traces. The output of a given sensor or group of sensors can be adjusted based on a temperature determined using one or more of the thermocouples using calibration data stored in memory associated with the processor (e.g., in memory 307 of processor 306). These data may include a single set of calibration factors for all of the sensors in the array. Alternatively, each sensor or group of sensors may have its own set of calibration factors for the range of temperatures.

As will be appreciated, the temperature used to select a calibration factor for a given sensor output may be derived in a number of ways. For example, a sensor's output might be adjusted based on the temperature reported from the nearest thermocouple. Alternatively, the reported temperatures from multiple thermocouples might be combined (e.g., via averaging, interpolation, etc.) to derive a value that might better represent, for example, the temperature at the location of each sensor. As will also be appreciated, the number and distribution of thermocouples may vary for different applications based on, for example, a desired resolution and/or accuracy in determining temperature (which may correspond to how accurate the sensors need to be), the available area, etc. For example, many vehicle seats include heater layers that affect some areas of the seats more than others. Moreover, the presence of an occupant can trap heat from the occupant's body and/or a heater. It is therefore desirable to adjust the number and distribution of temperature sensing devices so that sensor outputs can be adjusted to achieve the desired level of accuracy in reporting forces on the seat.

For examples of thermocouple structures that may be used with various implementations, please refer to U.S. Pat. No. 4,438,291 entitled Screen-Printable Thermocouples issued Mar. 20, 1984, Eichelberger et al., the entire disclosure of which is incorporated herein by reference for all purposes.

According to some implementations, the output of a given sensor or group of sensors can also be adjusted based on barometric pressure using calibration data stored in memory associated with the processor (e.g., in memory 307 of processor 306). These data may include a single set of calibration factors for all of the sensors in the array. Alternatively, each sensor or group of sensors may have its own set of calibration factors for the range of barometric pressure. The barometric pressure may be measured using any of a wide variety of sensors such as, for example, the KP254 from Infineon Technologies AG, a miniaturized digital barometric air pressure sensor.

As will be appreciated, the barometric pressure used to select a calibration factor for a given sensor output may be derived in a number of ways. For example, a sensor's output might be adjusted based on the pressure reported from the nearest pressure sensor. Alternatively, the reported pressures from multiple sensors might be combined (e.g., via averaging, interpolation, etc.) to derive a value that might better represent, for example, the pressure at the location of each sensor. As will also be appreciated, the number and distribution of pressure sensors may vary for different applications based on, for example, a desired resolution and/or accuracy in determining barometric pressure (which may correspond to how accurate the sensors need to be), the available area, etc.

The need for barometric pressure sensors may be reduced or even eliminated if the enclosure in which the sensor system is deployed allows for venting. This may be achieved simply by including holes or vents in the enclosure. According to some implementations, venting components may also be used that regulate the internal pressure of an enclosure while resisting the entry of contaminants. Examples of such venting components are provided by W. L. Gore & Associates (also known as Gore).

As will be understood, the responses of the sensors in arrays enabled by the present disclosure may exhibit variation relative to each other even at the same temperature and barometric pressure. According to some implementations, calibrated sensor data are stored (e.g., in memory 307 of processor 306) representing the response of each of the sensors. As mentioned above, such data may account for temperature and/or barometric pressure. Calibration can also account for variations caused by mechanical differences experienced by different sensors based on where each sensor is located and the physical design of the vehicle seat. For example, calibration data can account for the proximity of a sensor to a seam in the seat covering or to an edge of the seat covering which is tufted. A sensor near a seam or tufting is likely to respond to force differently than a sensor that is distant from a seam or tufting. Such data may be used for ensuring consistency in the way the sensor outputs are processed and/or used to represent applied forces. During calibration, the output of each sensor (e.g., as captured by ADC 304) is measured for a range of known input forces (and possibly temperatures as well). This may be done, for example, by placing each sensor on a scale, applying force to that sensor, and recording a value in memory for each of a plurality of ADC values that represents a corresponding value reported by the scale at a given temperature. In this way, a set of data points for each sensor is captured (e.g., in a table in memory 307) associating ADC values with corresponding forces (e.g., weights in grams or kilograms) and temperatures. The data set for each sensor might capture a force value for every possible value of the ADC output and for very small changes in temperature. Alternatively, fewer data points may be captured and the sensor circuitry may use interpolation to derive force values for ADC outputs not represented in the data set. In addition, for implementations in which the effect of temperature and/or barometric pressure on sensor outputs are taken into account, the calibration data for each may be determined and applied independently or, alternatively, determined and applied in an integrated manner. Variations on these themes will be understood by those of skill in the art.

Generating the set of data points for each sensor may be done by applying the force individually to each sensor using, for example, a device with a footprint that matches the sensor's active area configuration (e.g., see the shape of sensor S1 of FIG. 1). It may also be done by applying force simultaneously over multiple sensors (potentially up to the entire array) using, for example, a precision inflatable bladder that distributes force evenly over the set of sensors. The measurements for a given force can then be captured by activating the sensors sequentially. Other variations will be appreciated by those of skill in the art. Regardless of how the calibration force is applied, what results is data set that the processor may use to map the output received from each sensor to an accurate representation of the force represented. As will be appreciated, this consistency of representation may be important for some applications.

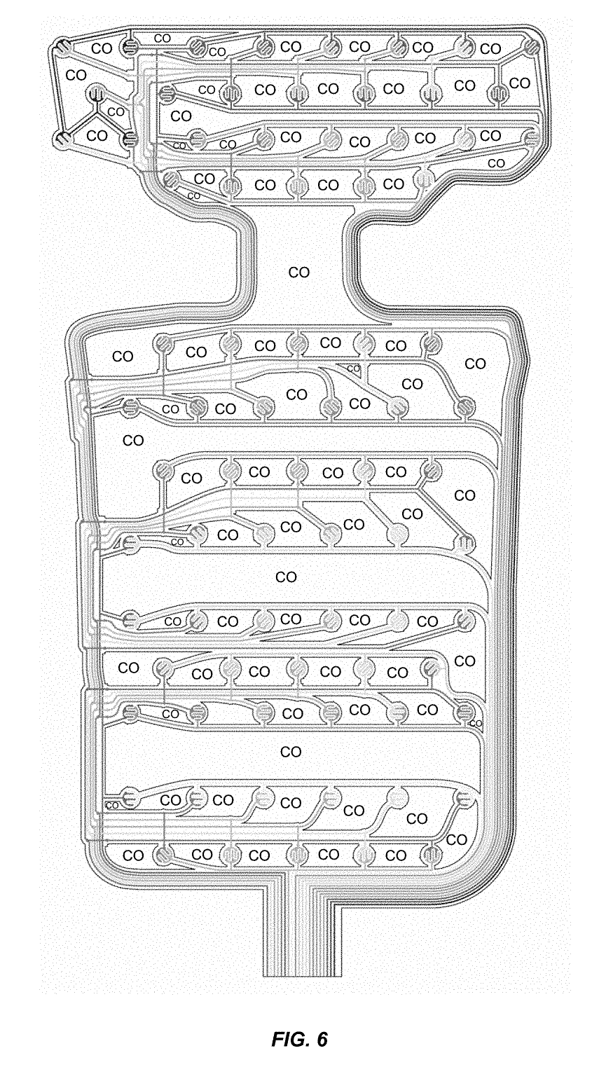

FIG. 6 illustrates a variation of the class of implementations illustrated in FIG. 1 in which much of the upper and lower substrates that don't include sensors and traces is removed as represented by the relief cutouts designated “CO,” i.e., the contiguous region around each instance of the designation “CO” represents an aperture in the assembly. Sufficient margin around the sensors and traces is provided to maintain the environmental seal that preserves the integrity of the conductive inks. The cutouts allow each sensor or set of sensors mechanical freedom to move more independently of their neighbors. This increases the range and/or sensitivity of each sensor or set of sensors in that the force applied to a given sensor or set of sensors is not averaged over a larger surface area of the assembly as would be the case without the cutouts. In addition, because each sensor or set of sensors activates more independently of its neighbors, this increases the accuracy with which the forces reported by that sensor or set of sensors may be captured. Another advantage of the cutouts relates to the fact that certain materials emit a crinkling sound that may be unpleasant to users. The cutouts significantly reduce this effect.

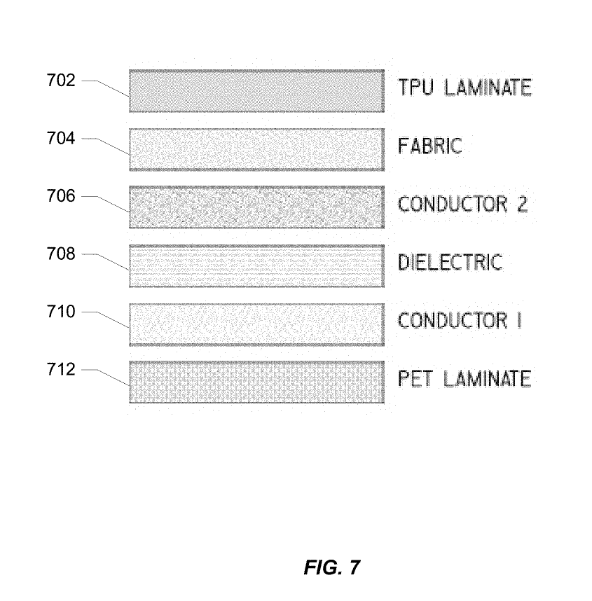

FIG. 7 shows different assembly layers that may exist at or near one of the sensors according to a particular implementation. These include the upper substrate (TPU laminate 702), the piezoresistive element (fabric 704), one trace (conductor 706), an insulator for where the traces might overlap (dielectric 708), another trace (conductor 710), and the lower substrate (PET laminate 712). As will be appreciated, depending on the location in the assembly, only a subset of the depicted layers will be present. For example, the piezoresistive material will only be at the locations of the sensors. In another example, along one of the routing traces there might only be the upper substrate, one conductor, and the lower substrate. In another example, between the traces of a particular sensor, a cross-section would show only the piezoresistive fabric and the two laminates. In another example that includes thermocouples, additional layer types corresponding to the thermocouple structure would be present. Other variations will be appreciated by those of skill in the art.

Implementations enabled by the present disclosure are capable of providing a rich data set representing the forces on a vehicle seat; enabling detection not only of the weight of an object or occupant, but how that weight is distributed; at any given moment and over time. At least some of the implementations described above allow for the detection of forces as low as about 300 grams with the spacing of the 78 sensors providing a nominal 10 mm resolution. Of course, finer or cruder resolutions may be achieved. That is, the dynamic range of individual sensors and the resolution the sensor data represent may vary considerably within the scope of this disclosure. A wide range of resolutions may be achieved by the number and spacing of sensors, as well as through the use of interpolation of data from multiple sensors. The scope of the present disclosure should therefore not be limited by reference to the specific examples described.

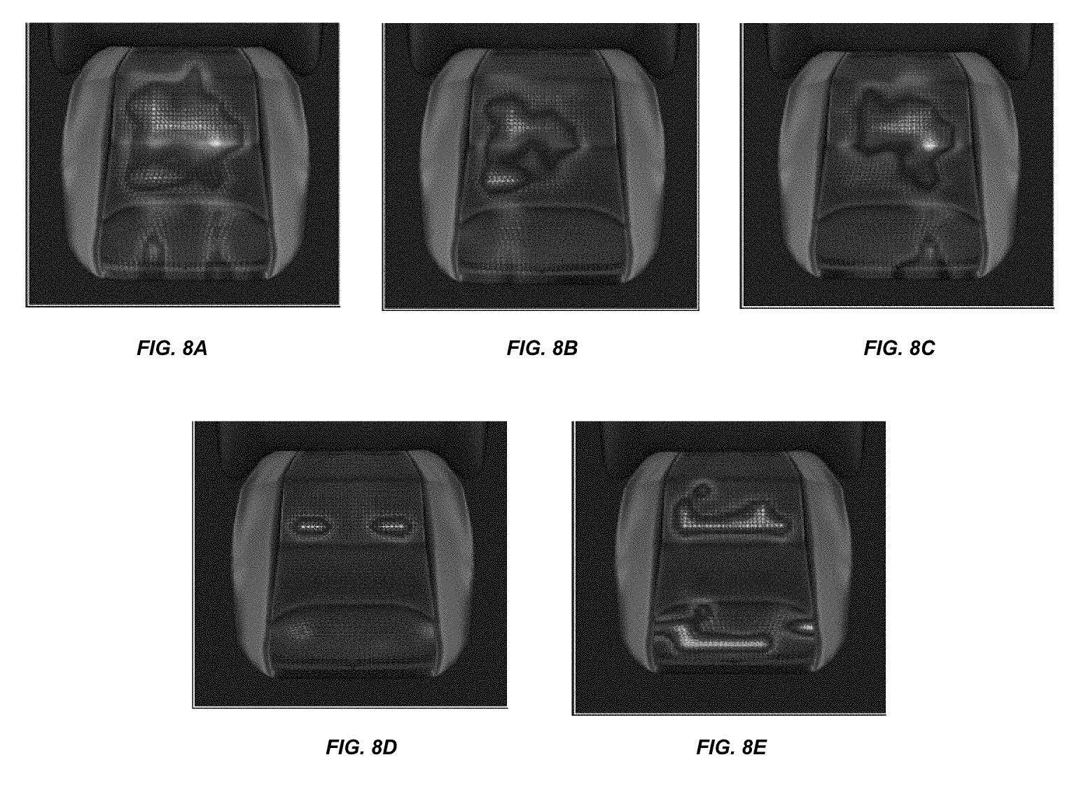

FIGS. 8A-8E graphically illustrate the nature of the data that can be captured with “pressure maps” that provide a visual representation of the sensor data. The depicted views look down on the bottom seat cushion with the front of the seat cushions being at the lower edge of each view. FIGS. 8A, 8B, and 8C show pressure maps representing the data generated with an adult vehicle occupant sitting with legs straight (8A), with the left leg crossed over the right (8B), and with the right leg crossed over the left (8C). The different shadings represent variations in the magnitude of the force detected. As will be appreciated from these illustrations, the sensor data may represent whether the seat occupant is leaning forward, leaning back, etc., as well as how the forces on the seat change over time. The sensor data can also represent or be used to detect different types of objects that might have different pressure map “signatures.” For example, FIG. 8D shows the pressure map for an empty car seat, while FIG. 8E shows the pressure map for the same car seat with a weight in it. Representations of the forces associated with such common objects may be stored in memory (e.g., in memory 307 of processor 306) for the purpose of supporting such object recognition.

Sensor data generated by a sensor implemented as described herein may be processed in a variety of ways to achieve a classification decision. Classification can be achieved for a range of object types and subtypes including, for example, various types of inanimate objects (e.g., a child car seat), living entities (e.g., different sized humans in various seating positions, different types and sizes of pets, etc.), or weight classes, based on a variety of models. Machine learning techniques may be leveraged to improve such models and performance over time.

A suitable representation of a feature set that may be used by such techniques might be, for example, a vector that includes numeric representations derived from the sensor data as operands. The operands may be weighted for different kinds of emphasis. Such a vector might be used, for example, as a test vector for a Support Vector Machine (SVM) machine learning process. Other possible representations would depend on the kind of machine learning techniques employed (e.g., regression analysis, neural networks, deep learning techniques, etc.).

Once generated, the training vectors are processed by a machine learning algorithm to build a model for each possible object classification. The classification algorithm then applies the learned model to the data to be classified, i.e., real time sensor data. It should be noted that any vector-space classification algorithm can be used. That is, in addition to an SVM, a wide variety of suitable alternatives exist including, for example, Naïve Bayesian classifiers, linear discriminant classifiers, neural networks, and Bayesian networks.

According to a particular class of implementations, raw sensor data is mapped to a representation of the physical geometry and orientation of the sensor system in three-dimensional (3D) space. This may be achieved, for example, by mapping the data to vertices on a 3D virtual model, or by mapping and interpolating the two-dimensional data onto a 3D surface.

When the data have been mapped to a 3D representation, further processing may be done in order to prepare for analysis. Such processing may include, for example, buffering, smoothing/averaging, clipping, offsetting or adding gain, etc. These operations can be performed on the data for each sensor, or applied to various aggregations of the data.

The sensor data can then be analyzed and features may be extracted for classification using, for example, techniques similar to those used in computer vision applications. Feature extraction may be done for all of the sensors collectively, as well as on subgroups of sensors. Examples of features include (but are not limited to) sum, average, thresholds, number of blobs (a contiguous group of sensors based on a common trait), blob distribution, blob size, centroid, shape, motion, weight, pressure distribution, trigger events, and changes in features or components of features over time. Environmental data may also be included in the feature set. Such data may be provided by additional sensors such as, for example, thermistors for temperature (as described above), and/or from auxiliary processing modules (e.g., an automotive computer).

It will be understood by those skilled in the art that changes in the form and details of the implementations described herein may be made without departing from the scope of this disclosure. For example, implementations have been described above in which the piezoresistive material with which the sensors are implemented is provided in isolated patches. However, it should be noted that implementations are contemplated in which larger pieces of piezoresistive material may be used to implement multiple sensors or even the entire array of sensors. That is, the piezoresistive material may be a flexible fabric or other material that is continuous over multiple sensors or the entire array. And for such implementations, the sensor trace patterns and routing traces may be printed, deposited, or otherwise formed directly on the piezoresistive material, the adjacent substrate, or both.

It should also be noted that the information from sensor systems enabled by the present disclosure may be used in a variety of ways. For example, the sensor data or information derived from the sensor data may be used in controlling and/or moderating the deployment of air bags and other active restraint systems. In another example, the sensor data or information derived from the sensor data may be used with autonomously driven vehicles, e.g., determining that an actual human is behind the wheel before overriding the auto pilot, or using information about the presence or absence of a passenger as input to driving software to inform decision making relating to collisions with other vehicles or obstructions. In another example, information about the distribution of weight in a vehicle can be used to improve the operation of a vehicle's suspension system, anti-lock braking system, and/or any of a variety of other systems that affect vehicle performance. In another example, sensor data or information derived from the sensor data might be used to recognize specific vehicle occupants for the purpose of adjusting various vehicle systems (seat position, mirrors, environmental controls, entertainment system, etc.) according to the stored preferences of that occupant.

Implementations are also contemplated in which additional sensors implemented as described herein may be integrated or aligned with the back of the seat, the headrest, and/or with the floor of the vehicle (or a floor mat) in front of the seat. As will be appreciated, such additional sensors could provide additional detail regarding the size and weight of a seat occupant, as well as the occupant's seating position. Such additional detail could support more fine grained decision making by an OCS and the systems that rely on the OCS. The additional sensors may be part of the same assembly as the sensors associated with the bottom seat cushion (e.g., as additional extensions to sensor system 100 of FIG. 1). Alternatively, the additional sensors could be provided in separate assemblies that are integrated or aligned with their respective parts of the seat, and/or floor, or floor mat.

Finally, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A sensor system, comprising:
an array of sensors arranged in a flexible assembly, the flexible assembly being configured for integration with a seat, each sensor including a piezoresistive element and a sensor trace pattern comprising two closely spaced conductive sensor traces, each sensor also being connected to a pair of conductive routing traces configured to receive a drive signal and transmit a sensor signal, each sensor signal being representative of a force applied to the corresponding sensor, wherein the sensor trace patterns and the conductive routing traces for the sensors of the array are formed on a flexible substrate, and wherein the piezoresistive elements for the sensors of the array are secured to the flexible substrate in contact with the corresponding sensor trace patterns; and
sensor circuitry connected to the conductive routing traces and configured to selectively energize the sensors of the array with the drive signals and to receive the sensor signals.

2. The sensor system of claim 1, further comprising a plurality of temperature sensing elements formed on the flexible substrate, each of the temperature sensing elements being configured to generate a temperature signal representative of a temperature of the flexible assembly in a vicinity of the temperature sensing element, wherein the sensor circuitry is further configured to receive the temperature signals, and to modify force values derived from the sensor signals using correction values corresponding to the temperature signals.

3. The sensor system of claim 1, further comprising one or more barometric pressure sensing elements, each of the barometric pressure sensing elements being configured to generate a pressure signal representative of a barometric pressure in a vicinity of the barometric pressure sensing element, wherein the sensor circuitry is further configured to receive each pressure signal, and to modify force values derived from the sensor signals using correction values corresponding to each pressure signal.

4. The sensor system of claim 1, wherein the flexible assembly includes two portions, a first portion of the assembly being configured for alignment with a top of a seat cushion of the seat, and a second portion of the assembly being configured for alignment with a front of the seat cushion of the seat.

5. The sensor system of claim 1, wherein the sensor system is configured for integration with one or more of a seat cushion of the seat, a back cushion of the seat, and/or a headrest of the seat.

6. The sensor system of claim 1, further comprising an additional array of sensors arranged in an additional flexible assembly, the additional flexible assembly being configured for integration with a floor adjacent the seat.

7. The sensor system of claim 1, wherein the piezoresistive elements are secured to the flexible substrate with a material that forms a hermetic seal with the flexible substrate around each sensor.

8. The sensor system of claim 1, wherein the flexible assembly has a plurality of cut-out apertures between subsets of the sensors of the array such that each subset of the sensors of the array has a degree of independent motion relative to other subsets of the sensors of the array.

9. The sensor system of claim 1, wherein the sensor trace patterns and the conductive routing traces for the sensors of the array comprise one or more conductive inks screen printed on the flexible substrate.

10. The sensor system of claim 1, wherein the sensor circuitry is further configured to process the sensor signals to generate force data representing a distribution of force magnitudes over one or more areas of the seat.

11. The sensor system of claim 10, wherein the force data further represent the distribution of the force magnitudes over time.

12. The sensor system of claim 10, wherein the sensor circuitry is further configured to transmit the force data to an occupant classification system of a vehicle in which the seat is included.

13. The sensor system of claim 1, wherein the sensor circuitry is further configured to process the sensor signals to identify a type of object or a type of occupant in the seat.

14. A vehicle seat, comprising:
a chassis;
one or more cushions;
a seat cover securing the cushions to the chassis;
a sensor system including:
an array of sensors arranged in a flexible assembly, the flexible assembly being adjacent the one or more cushions within the seat cover, each sensor including a piezoresistive element and a sensor trace pattern comprising two closely spaced conductive sensor traces, each sensor also being connected to a pair of conductive routing traces configured to receive a drive signal and transmit a sensor signal, each sensor signal being representative of a force applied to the corresponding sensor, wherein the sensor trace patterns and the conductive routing traces for the sensors of the array are formed on a flexible substrate, and wherein the piezoresistive elements for the sensors of the array are secured to the flexible substrate in contact with the corresponding sensor trace patterns;
sensor circuitry connected to the conductive routing traces and configured to selectively energize the sensors of the array with the drive signals and to receive the sensor signals, the sensor circuitry being further configured to generate force data using the sensor signals, the force data representing a distribution of force magnitudes over one or more areas of the vehicle seat; and
an interface configured to transmit communications based on the force data to an automotive system of a vehicle in which the vehicle seat is mounted.

15. The vehicle seat of claim 14, wherein the sensor system further includes a plurality of temperature sensing elements formed on the flexible substrate, each of the temperature sensing elements being configured to generate a temperature signal representative of a temperature of the flexible assembly in a vicinity of the temperature sensing element, wherein the sensor circuitry is further configured to receive the temperature signals, and to modify force values derived from the sensor signals using correction values corresponding to the temperature signals.

16. The vehicle seat of claim 14, further comprising one or more barometric pressure sensing elements, each of the barometric pressure sensing elements being configured to generate a pressure signal representative of a barometric pressure in a vicinity of the barometric pressure sensing element, wherein the sensor circuitry is further configured to receive each pressure signal, and to modify force values derived from the sensor signals using correction values corresponding to each pressure signal.

17. The vehicle seat of claim 14, wherein the flexible assembly includes two portions, a first portion of the assembly being aligned with a top of a seat cushion of the seat, and a second portion of the assembly being aligned with a front of the seat cushion of the seat.

18. The vehicle seat of claim 14, wherein the sensor system is aligned with one or more of a seat cushion of the seat, a back cushion of the seat, and/or a headrest of the seat.

19. The vehicle seat of claim 14, wherein the piezoresistive elements are secured to the flexible substrate with a material that forms a hermetic seal with the flexible substrate around each sensor.

20. The vehicle seat of claim 14, wherein the flexible assembly has a plurality of cut-out apertures between subsets of the sensors of the array such that each subset of the sensors of the array has a degree of independent motion relative to other subsets of the sensors of the array.

21. The vehicle seat of claim 14, wherein the sensor trace patterns and the conductive routing traces for the sensors of the array comprise one or more conductive inks screen printed on the flexible substrate.

22. The vehicle seat of claim 14, wherein the automotive system is an occupant classification system, and the sensor circuitry is configured to transmit the force data to the occupant classification system via the interface.

23. The vehicle seat of claim 14, wherein the sensor circuitry is further configured to process the force data to identify a type of object or a type of occupant in the seat.
